(19) United States
(12) Patent Application Publication
(10) Pub. No.: US 2007/0006195 A1
(43) Pub. Date: Jan. 4, 2007

(54) Method and structure for explicit software control of data speculation

(76) Inventors: Christof Braun, Doonan (AU); Quinn A. Jacobson, Sunnyvale, CA (US); Shailender Chaudhry, San Francisco, CA (US); Marc Tremblay, Menlo Park, CA (US)

Correspondence Address: GUNNISON MCKAY & HODGSON, LLP, 1900 GARDEN ROAD, SUITE 220, MONTEREY, CA, 93940, US

(21) Appl. No.: 11/082,281

(22) Filed: Mar. 16, 2005

Related U.S. Application Data
(60) Provisional application No. 60/558,377, filed on Mar. 31, 2004.

(51) Int. Cl. G06F 9/45

(52) U.S. Cl. 717/151

(57) ABSTRACT

Explicit software control is used for data speculations. The explicit software control is applied at selected locations in a computer program to provide the benefit of data speculation while eliminating the need for hardware to perform data speculation. A computer-based method first determines, via explicit software control, whether data speculation for an item, a variable, a pointer, an address, etc., is needed. Upon determining that data speculation for the item is needed, the data speculation is performed under explicit software control. Conversely, if the explicit software control determines that data speculation is not needed, e.g., the value of the item typically obtained by execution of a long latency instruction, is available, an original code segment is executed using an actual value of the item.

### RELATED APPLICATIONS

This application claims the benefit of U.S. Provisional Application No. 60/558,377 filed Mar. 31, 2004 entitled “Method And Structure For Explicit Software Control Of Data Speculation” and naming Christof Braun, Quinn A. Jacobson, Shailender Chaudhry and Marc Tremblay as inventors, which is incorporated herein by reference in its entirety.

### BACKGROUND OF THE INVENTION

1. Field of the Invention

The present invention relates generally to enhancing performance of processors, and more particularly to methods for data speculation.

2. Description of Related Art

To enhance the performance of modern processors, various techniques are used to enhance the number of instructions executed in a given time period. One of these techniques is data speculation.

Data speculation, in general, refers to forms of speculation where data values, either the source or result of operations, are predicted to break data dependencies. By breaking data dependencies, more instructions can be issued in parallel. Some form of checking is used to make sure that the prediction was correct, and to back up in the case of an incorrect speculation. If the speculation were correct, potentially dependent operations are executed in parallel reducing the absolute execution time.

Many forms of data speculation have been proposed to increase instruction-level parallelism (ILP) and many hardware mechanisms have been proposed to support data speculation. Data speculation is most important for long latency operations.

An example of the application of hardware based data speculation is to predict the value returned by a load instruction that misses in the memory caches close to the processor. If the value returned by the load can be predicted, subsequent instructions that depend on the value are executed while the load is still completing. When the load completes the speculation is checked and either the work done for subsequent instructions is considered correct and committed, or the work done must be discarded.

There are two fundamental things needed to make data speculation work. First, there must be a good way to predict the data value that an instruction is either going to use or to produce. The prediction could come from hardware mechanisms that observe previous behavior and use the previous behavior to predict future behavior. The prediction could also be incorporated into the software application itself.

The second thing needed for data value speculation is hardware support for speculative execution. All the subsequent instructions (that use the predicted data value) after the point of prediction must be executed in such a way that the instructions can later be committed to the architectural state, or discarded without affecting the architectural state. There must be support to remember the predicted data value used and compare the predicted data value against the actual data value returned by the instruction and to initiate either the committing or discarding of subsequent instructions.

### SUMMARY OF THE INVENTION

According to one embodiment of the present invention, explicit software control is used for data speculations. The explicit software control is applied at selected locations in a computer program to provide the benefit of data speculation while eliminating the need for hardware to perform data speculation.

Hence, in an embodiment, a computer-based method first determines, via explicit software control, whether data speculation for an item, a variable, a pointer, an address, etc., is needed. Upon determining that data speculation for the item is needed, the data speculation is performed under explicit software control. Conversely, if the explicit software control determines that data speculation is not needed, e.g., the value of the item typically obtained by execution of a long latency instruction, is available, an original code segment is executed using an actual value of the item.

In one example, determining whether data speculation for the item is needed includes executing a branch on register status instruction. This instruction exposes a processor scoreboard and allows the software to determine the status of the item in the scoreboard.

In one example, the performing data speculation under explicit software control includes directing hardware to checkpoint a state to obtain a snapshot state. A value of the item is set to a predicted value of the item and then the original code segment is executed using the predicted value in place of an actual value. Upon completion of the execution of the original code segment, the predicted value of the item is compared to the actual value of the item. If the two values are equal, a result of executing the original code segment using the predicted value of the item is committed. Conversely, if the two values are not equal, the state is rolled back to the snapshot state, and the original code segment is executed using the actual value.

For this embodiment, a structure includes a means for determining whether data speculation, under explicit software control, for an item is needed and means for performing data speculation under explicit software control, upon determining data speculation is needed. The structure also includes means for executing an original code segment using an actual value of the item upon determining data speculation is not needed.

In one embodiment, the means for performing data speculation includes means for directing hardware to checkpoint a state to obtain a snapshot state. The means for performing data speculation also includes means for setting a value of an item to a predicted value of the item and means for executing an original code segment using the predicted value in place of the actual value. The means for performing data speculation further includes means for comparing the predicted value to the actual value and means for committing a result of executing the original code segment using the predicted value upon the predicted value being equal to the actual value.

These means can be implemented, for example, by using stored computer executable instructions and a processor in a computer system to execute these instructions. The computer system can be a workstation, a portable computer, a client-server system, or a combination of networked computers, storage media, etc.

A computer system includes a processor and a memory coupled to the processor and having stored therein instructions. Upon execution of the instructions on the processor, a method comprises:
determining, under explicit software control, whether data speculation for an item is needed; and
performing data speculation for the item, under explicit software control, upon determining data speculation is needed.

A computer-program product comprises a medium configured to store or transport computer readable code for a method comprising:
determining, under explicit software control, whether data speculation for an item is needed; and
performing data speculation for the item, under explicit software control, upon determining data speculation is needed.

In another embodiment, a computer-based method includes executing a branch on register status instruction, executing an original code segment using an actual value of the register upon the register status being a first state and performing, alternatively, data speculation, under explicit software control, for the original code segment, upon the register status being a second state different from the first state.

For this embodiment, a structure includes: means for executing a branch on register status instruction; means for executing an original code segment using an actual value of the register upon the register status being a first state; and means for performing, alternatively, data speculation under explicit software control for the original code segment upon the register status being a second state different from the first state.

These means can be implemented, for example, by using stored computer executable instructions and a processor in a computer system to execute these instructions. The computer system can be a workstation, a portable computer, a client-server system, or a combination of networked computers, storage media, etc.

For this embodiment, a computer system includes a processor and a memory coupled to the processor and having stored therein instructions. Upon execution of the instructions on the processor, a method comprises:
executing a branch on register status instruction;
executing an original code segment using an actual value of the register upon the register status being a first state; and
performing, alternatively, data speculation under explicit software control, for the original code segment, upon the register status being a second state different from the first state.

A computer-program product comprises a medium configured to store or transport computer readable code for a method comprising:
executing a branch on register status instruction;
executing an original code segment using an actual value of the register upon the register status being a first state; and
performing, alternatively, data speculation under explicit software control for the original code segment, upon the register status being a second state different from the first state.

In still yet another embodiment, a method includes:
determining whether data speculation for an item is needed in a computer source program; and
inserting computer program code in the computer source program that upon execution provides explicit software control of the data speculation.

For this embodiment, a structure includes: means for determining whether data speculation for an item is needed in a computer source program; and means for inserting computer program code in the computer source program that upon execution provides explicit software control of the data speculation.

These means can be implemented, for example, by using stored computer executable instructions and a processor in a computer system to execute these instructions. The computer system can be a workstation, a portable computer, a client-server system, or a combination of networked computers, storage media, etc.

For this embodiment, a computer system includes a processor and a memory coupled to the processor and having stored therein instructions. Upon execution of the instructions on the processor, a method comprises:
determining whether data speculation for an item is needed in a computer source program; and
inserting computer program code in the computer source program that upon execution provides explicit software control of the data speculation

A computer-program product comprises a medium configured to store or transport computer readable code for a method comprising:
determining whether data speculation for an item is needed in a computer source program; and
inserting computer program code in the computer source program that upon execution provides explicit software control of the data speculation.

In still another embodiment, a structure includes means for executing an instruction to perform a checkpoint of state and means for beginning speculative execution of at least one instruction. The structure further includes means for committing work done by the speculative execution upon the speculative execution being successful, and meaning for discarding the work upon the speculative work being unsuccessful and rolling back to the state.

### BRIEF DESCRIPTION OF THE DRAWINGS

FIG. 1 is a block diagram of a system that includes a source program including a single thread data speculation code sequence that provides explicit software control of the data speculation according to a first embodiment of the present invention.

FIG. 2 is a process flow diagram for one embodiment of inserting a single thread data speculation code sequence for explicit software control of data speculation at appropriate points in a source computer program according to one embodiment the present invention.

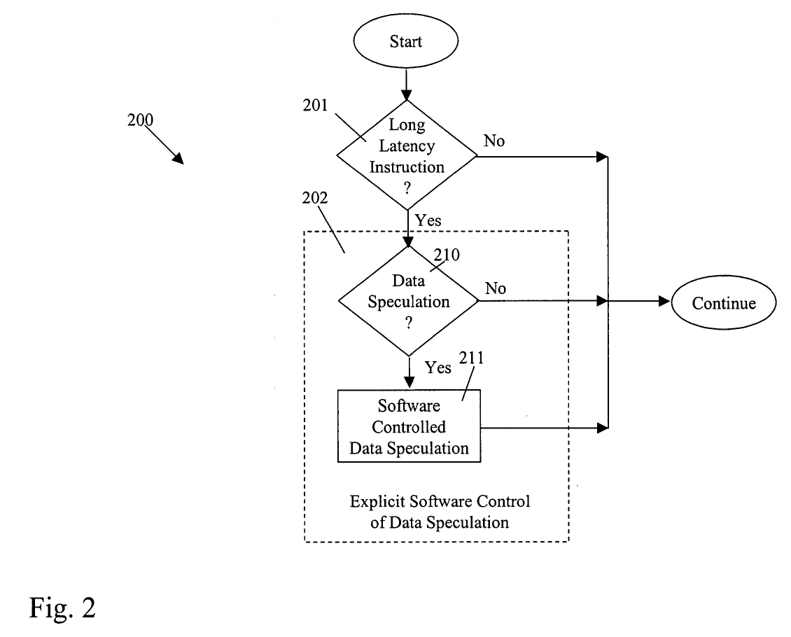

FIG. 3 is a process flow diagram for explicit software control of data speculation according to one embodiment of the present invention.

FIG. 4 is a process flow diagram for explicit software control of data speculation according to another embodiment of the present invention.

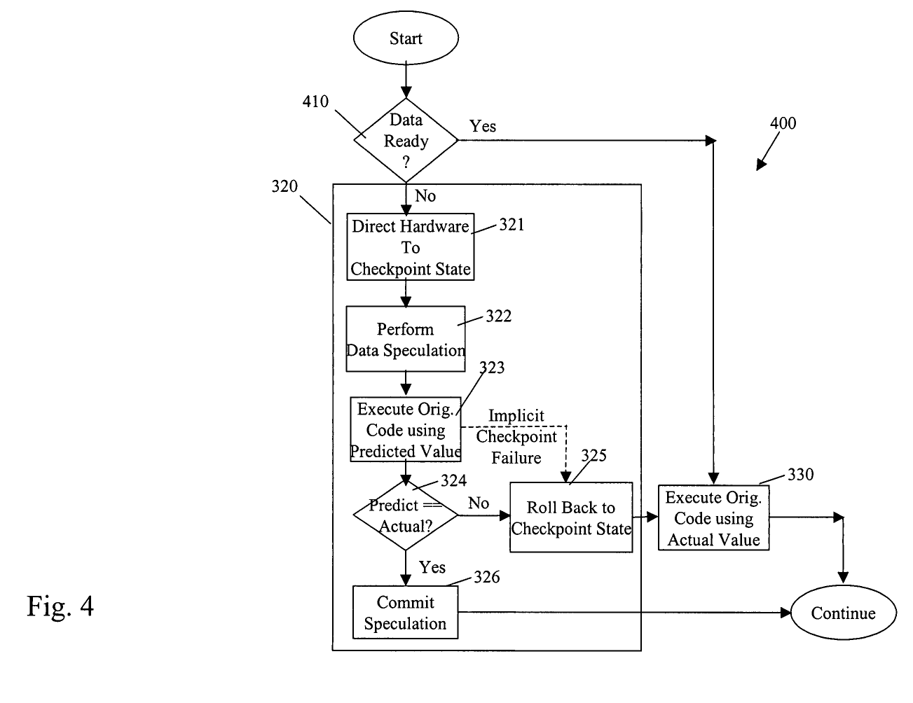

FIG. 5 is a high-level network system diagram that illustrates several alternative embodiments for using a source program including a single thread data speculation code sequence that provides explicit software control of the data speculation.

In the drawings, elements with the same reference numeral are the same or similar elements. Also, the first digit of a reference numeral indicates the figure number in which the element associated with that reference numeral first appears.

### DETAILED DESCRIPTION

According to one embodiment of the present invention, data speculation for an item is performed under explicit software control. A series of software instructions in a single thread data speculation code sequence 140 is executed on a processor 170 of computer system 100.

Execution of the series of software instructions in single thread data speculation code sequence 140 causes computer system 100 to (i) determine whether data speculation for the item is needed, and when data speculation is needed causes computer system to (ii) snapshot a state of computer system 100 and maintain a capability to roll back to that snapshot state, (iii) perform the data speculation for the item, (iv) execute a code segment that uses the result of the data speculation, (v) determine whether the data speculation is valid, (vi) commit the speculative work if the data speculation is valid and continues execution, or (vii) roll back to the snapshot state if the data speculation is invalid and continue execution.

A user can control the use of data speculation for an item using explicit software control in a source program 130. Alternatively, for example, a compiler or optimizing interpreter, in processing source program 130, can insert instructions that provide the explicit software control over the data speculation for items at points where long latency instructions are anticipated.

More specifically, in one embodiment, process 200 is used to modify program code to control data speculation using explicit software control. In long latency instruction check operation 201, a determination is made whether execution of an instruction is expected to require a large number of processor cycles. If the instruction is not expected to require a large number of processor cycles, processing continues normally and the code is not modified to include explicit software control of data speculation for the item associated with the long latency instruction. Conversely, if the instruction is expected to require a large number of processor cycles, processing transfers to explicit software control of data speculation operation 202 where instructions for explicit software control of data speculation for the item are included source program 130.

In this embodiment, an instruction or instructions are added to source program 130 that upon execution performs data speculation check operation 210. As explained more completely below, the execution of this instruction provides the program with explicit control over whether data speculation is performed. If data speculation is not needed, i.e., the value of the item is available, processing continues normally. Conversely, if data speculation is needed, data speculation check operation 210 transfers processing to software controlled data speculation operation 211.

In software controlled data speculation operation 211, in this embodiment, instructions are included so that operations (ii) to (vii) as described above are performed in response to execution of a segment of software code. Specifically, a software instruction directs processor 170 to take a snapshot of a state, and to manage all subsequent changes to that state so that if necessary, processor 170 can revert to the state at the time of the snapshot.

The snapshot taken depends on the state being captured. In one embodiment, the state is a system state. In another embodiment, the state is a machine state, and in yet another embodiment, the state is a processor state. In each instance, the subsequent operations are equivalent.

Following the snapshot, the value of the item for which data speculation is being performed is set equal to the predicted value of the item. Next, the original code sequence is executed using the predicted value of item.

When execution of the code sequence completes, the predicted value of the item is compared with the actual value of the item. If the two values are the same, the results of the computation are committed and otherwise the state is rolled back to the snapshot state and execution continues with the actual value of the item.

For the explicit software control of data speculation to be beneficial, the software application ideally has three characteristics. First, there must be an operation for which the result is available after a long latency. The most common cause would be a long latency operation like a load that frequently misses the caches. Second, the result of the operation is predictable. Third, subsequent operations are dependent on the result of the long latency operation.

In one embodiment, software is used to implement process 200 and the software identifies each instruction on which to speculate on the value that results from execution of the instruction. This can be done from programmer directives, compiler analysis, or profiler feedback. Independent of the process used to identify the instructions, the process makes the decision that it is potentially beneficial to break the data dependency by speculating on the result value of an operation.

Other embodiments for determining where to insert explicit software control of data speculation in source program 130, e.g., insertion points, are disclosed in commonly assigned U.S. patent Ser. No. 10/349,425, entitled “METHOD AND STRUCTURE FOR CONVERTING DATA SPECULATION TO CONTROL SPECULATION” of Quinn A. Jacobson. The Summary of the Invention, Description of the Drawings, Detailed Description and the drawings cited therein, Claims and Abstract of U.S. patent application Ser. No. 10/349,425 are incorporated herein by reference in their entireties. The code segments inserted in U.S. patent application Ser. No. 10/349,425 would be replaced with the explicit software control as described more completely below. Also, note that the embodiments of U.S. patent application Ser. No. 10/349,425 are examples of other embodiments of explicit software control of data speculation.

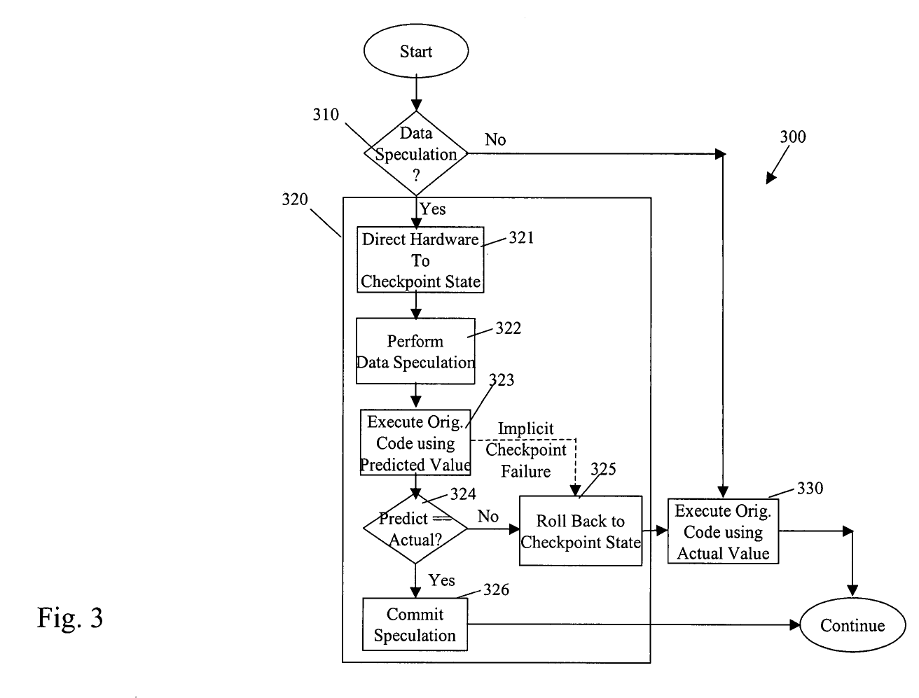

FIG. 3 is a more detailed process flow diagram for a method 300 for one embodiment of the instructions added, using method 200, to provide explicit software control of data speculation for an item. To further illustrate method 300, pseudo code for various examples are presented below. An example pseudo code segment selected for data speculation is presented in TABLE 1.

TABLE 1

1 Producer_OP A, B -> %rZ
. . .
2 Consumer_OP %rZ, C -> D
. . .

Line 1 (The line numbers are not part of the pseudo code and are used for reference only.) is an operation, Producer_OP, that uses items A and B and places the result of the operation in register % rz. Operation Producer_OP can be any operation supported in the instruction set. Items A and B are simply used as placeholders to indicate that this particular operation requires two inputs. The various embodiments of this invention are also applicable to an operation that has a single input, or more than two inputs. Register % rZ can be any register. The result of operation Producer_OP is not available until after a long latency, and the result is expected to be value N, where N is either an absolute value or a value available in a register.

Line 2 is an operation Consumer_OP. Operation Consumer_OP uses the result of operation Producer_OP that is stored in register % rZ. Items C and D are simply used as place holders to indicate that this particular operation requires two inputs % RZ and C and has an output D. While in this embodiment operation Consumer_OP is represented by a single line of pseudo-code, operation Consumer_OP represents a code segment that uses the result of operation Producer_OP. The code segment may include one of more lines of software code.

The pseudo code generated by using method 200 for the pseudo code in TABLE 1 is presented in lines Insert_{—}21 to Insert_{—}30 of TABLE 2.

TABLE 2

```
1  Producer_OP A, B -> %rZ
Insert_21 if data_speculation, branch predict
. . .
Insert_22 original:
2  Consumer_OP %rZ, C -> D
Insert_23 continue:
Insert_24 <update prediction for result of
      Producer_OP>
. . .
Insert_25 predict;
Insert_26 checkpoint, original
Insert 27 <Compute or use prediction for result of
      Producer_OP and store in %rZ1>
Insert 28 Consumer_OP %rZ1, C -> D
Insert_29 If %rZ = = %rZ1, commit, else fail
Insert_30 ba continue
```

Again, the line numbers are not part of the pseudo code and are used for reference only.

In this example, line 1 is identified as an insertion point and so a code segment, including lines Insert_{—}21, Insert_{—}22, Insert_{—}23, Insert_{—}24, Insert_{—}25, Insert_{—}26, Insert_{—}27, Insert_{—}28, Insert_{—}29, and Insert_{—}30 are inserted using method 200. The specific implementation of this sequence of instructions is dependent upon factors including some or all of (i) the computer programming language used in source program 130, (ii) the operating system used on computer system 100 and (iii) the instruction set for processor 170. In view of this disclosure, those of skill in the art can implement the conversion in any system of interest.

The inserted lines are first discussed and then method 300 is considered in more detail. Line Insert_{—}21 is a conditional flow control statement that upon execution determines whether data speculation is needed, e.g., is the actual result of operation Producer_OP available. If data speculation is needed, e.g., the result of operation Producer_OP is unavailable, processing branches to label predict, which is line Insert_{—}25. Otherwise, processing continues through label original, which is line Insert_{—}22, to line 2.

Line Insert_{—}23 is a label continue. Processing transfers to label continue following committing the results of the data speculation. Processing also transfers through label continue when data speculation is not needed, or when data speculation fails.

Line Insert_{—}24 is a code segment that updates the prediction of the value of operation Producer_OP. The instructions included here depend upon the type of value prediction. If a constant value prediction is being used, this instruction is a nop instruction. In other embodiments, last-value or striding predictors could be implemented. In general, one of skill in the art can use an appropriate value prediction scheme in software.

Line Insert_{—}26 is an instruction that directs the processor to take the state snapshot and to maintain the capability to rollback the state to the snapshot state. In this example, a checkpoint instruction is used.

A more detailed description of methods and structures related to the checkpoint instruction are presented in commonly assigned U.S. patent application Ser. No. 10/764,412, entitled “Selectively Unmarking Load-Marked Cache Lines During Transactional Program Execution,” of Marc Tremblay, Quinn A. Jacobson, Shailender Chaudhry, Mark S. Moir, and Maurice P. Herlihy filed on Jan. 23, 2004. The Summary of the Invention, Description of the Drawings, Detailed Description and the drawings cited therein, Claims and Abstract of U.S. patent application Ser. No. 10/764,412 are incorporated herein by reference in its entirety.

In this embodiment, the syntax of the checkpoint instruction is:
checkpoint, <label>
   where execution of instruction checkpoint causes the processor to take a snapshot of the state of this thread. Label <label> is a location that processing transfers to if the checkpointing fails, either implicitly or explicitly.

After a processor takes a snapshot of the state, the processor, for example, buffers new data for each location in the snapshot state. The processor also monitors whether another thread performs an operation that would affect the state of the speculative execution, e.g., writes to a location in the checkpointed state, or stores a value in a location in the checkpointed state. If such an operation is detected, the speculative work is flushed, the snapshot state is restored, and processing branches to label <label>. This is an implicit failure of the data speculation.

An explicit failure of the checkpointing is caused by execution of a statement Fail. The execution of statement Fail causes the processor to drop the speculative work, to restore the state to the snapshot state, and to branch to label <label>. Execution of a statement Commit causes the processor to commit all the speculative work done since the last checkpoint.

Line Insert_{—}27 is an instruction or code segment that upon execution determines the predicted value for operation Producer_OP and stores the predicted value in register % rZ1. For example, if a constant value prediction is used, the constant value is moved into register % rZ1.

In line Insert_{—}28, the code segment represented by line 2 is replaced with a similar code segment where the predicted value is used instead of the actual value of operation Producer_OP, i.e., register % rz is replaced with register % rz1 in the original code segment.

In line Insert_{—}29, the predicted value of operation Producer_OP is compared with the actual value of operation Producer_OP. If the two values are equal, the speculative work is committed by execution of instruction commit. If the two values are not equal, the speculative work is flushed, the state is returned to the snapshot state, and processing transfers to label original by execution of instruction fail. Thus, if line Insert_{—}30 is reached, the speculative work has been committed and so processing always branches to label continue.

When the code segment in TABLE 2 is executed on processor 170, method 300 is performed. In data speculation check operation 310, a check is made to determine whether data speculation is needed for the long latency instruction. For example, if the result of the long latency instruction was available, data speculation would not enhance performance. Thus, when the result of the long latency instruction is available, check operation 310 transfers processing to execute original code segment using actual value operation 330. Otherwise, when the result of the long latency instruction is unavailable, check operation 310 transfers processing to data speculation under explicit software control operation 320.

In one embodiment of data speculation under explicit software control operation 320, direct hardware to checkpoint state operation 321 causes a snapshot of the current state, the snapshot state, to be taken by processor 170. Upon completion of checkpoint state operation 321, processing transfers from operation 321 to perform data speculation 322.

Perform data speculation 322 sets a value of item obtained by execution the long latency instruction to a predicted value. Upon completion operation 322, processing transfers from operation 322 to execute original code segment using predicted value operation 323.

In operation 323, the original code segment is executed with the predicted value replacing the actual value in the original code segment. If there is an implicit checkpoint failure during the execution, the data speculation is terminated and processing transfers from operation 323 to roll back to check point state operation 325. Conversely, upon successful completion of execution, processing transfers from operation 323 to predicted equals actual check operation 324.

Predicted equals actual check operation 324 compares the predicted value of the long latency instruction with the actual value. If the two values are equal, the result of operation 323 is valid and processing transfers to commit speculation operation 326 that in turn commits the results of the execution based upon the data speculation. If the two values are not equal, the result of operation 323 is not valid and processing transfers to roll back to checkpoint state operation 325.

In roll back to checkpoint state operation 325, the snapshot state is restored as the actual state and processing transfers to execute original code using actual value operation 330. Execute original code using actual value operation 330 executes the original code segment using the actual value of the long latency instruction.

Method 400 is another embodiment of a process flow diagram for data speculation under explicit software control. In this embodiment, a novel data ready check operation 410 is used. Check operation 410 is implemented using an embodiment of a branch on status instruction, e.g., a branch on register status instruction. Execution of the branch on register status instruction tests scoreboard 173 of processor 170 at the time the branch on register status instruction is dispatched. If the register status is ready, execution continues. If the register status is not ready, execution branches to a label specified in the branch on register status instruction. The format for one embodiment of the branch on register status instruction is:
Branch_if_not_ready % reg label
where
   % reg is a register in scoreboard 173, which in this embodiment is a hardware instruction scoreboard, and
   label is a label in the data speculation code segment.

With this instruction, the pseudo code of TABLE 2 becomes:

TABLE 3

```
1  Producer_OP A, B -> %rZ
Insert_31 Branch_if_not_ready %rZ predict
. . .
Insert_22 original:
2  Consumer_OP %rZ, C -> D
Insert_23 continue:
Insert_24 <update prediction for result of
      Producer_OP>
. . .
Insert_25 predict;
Insert_26 checkpoint, original
Insert 27 <Compute or use prediction for result of
      Producer_OP and store in %rZ1>
Insert 28 Consumer_OP %rZ1, C -> D
Insert_29 If %rZ = = %rZ1, commit, else fail
Insert_30 ba continue
```

It is important that code making use of the branch on register status instruction understand the dispatch grouping rules and the expected latency of operations. If a branch on not ready instruction is issued immediately after a load instruction, the instruction typically sees the load as not ready because for example, the load has a three cycle minimum latency even for the case of a level-one data cache hit.

A more detailed description of the novel branch on status information instructions is presented in commonly filed, and commonly assigned U.S. patent application Ser. No. ______, entitled “METHOD AND STRUCTURE FOR EXPLICIT SOFTWARE CONTROL USING SCOREBOARD STATUS INFORMATION,” of Marc Tremblay, Shailender Chaudhry, and Quinn A. Jacobson (Attorney Docket No. SUN040062) of which the Summary of the Invention, Detailed Description, Claims, Abstract and the drawings cited in these sections and the associated Brief Description of the Drawings are incorporated herein by reference in their entireties.

Thus, with execution of the branch of register status instruction, data ready check operation 410 transfers to operation 330 if the status of register % rZ in scoreboard 173 is ready and to operation 320 if the status of register % rz is not ready. Operations 310 and 320 are the same as those described above and that description is incorporated herein by reference.

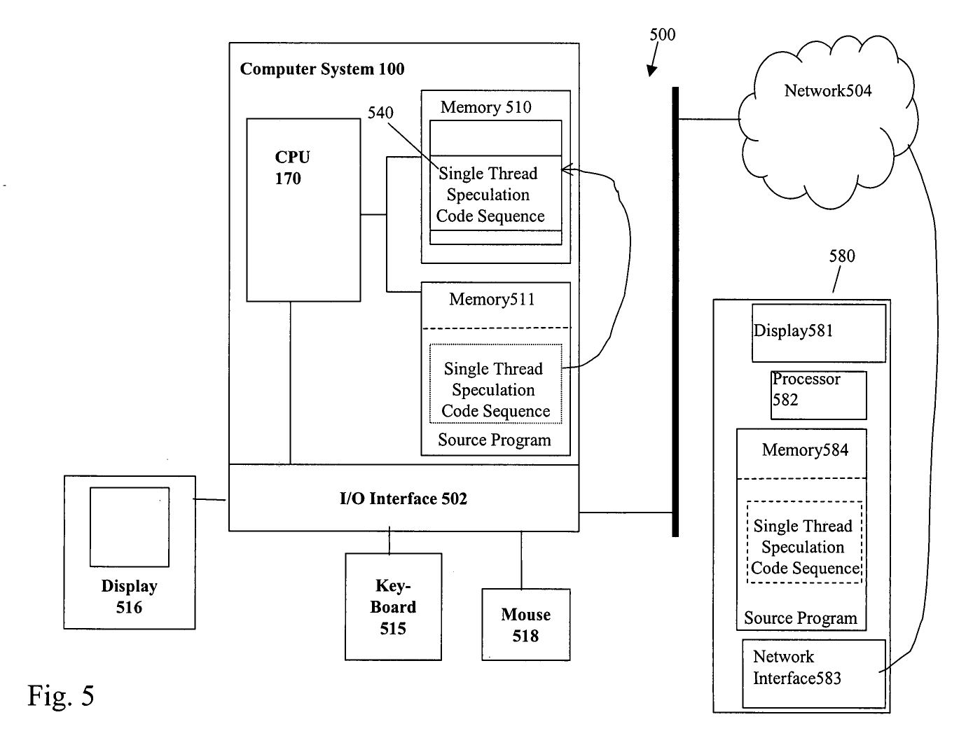

Those skilled in the art readily recognize that in this embodiment the individual operations mentioned before in connection with methods 300 and 400, are performed by executing computer program instructions on processor 170 of computer system 100. In one embodiment, a storage medium has thereon installed computer-readable program code for method 540, (FIG. 5) where method 540 is either or both of methods 300 and 400, and execution of the computer-readable program code causes processor 170 to perform the operations explained above.

In one embodiment, computer system 100 is a hardware configuration like a personal computer or workstation. However, in another embodiment, computer system 100 is part of a client-server computer system 500. For either a client-server computer system 500 or a stand-alone computer system 100, memory 120 typically includes both volatile memory, such as main memory 510, and non-volatile memory 511, such as hard disk drives.

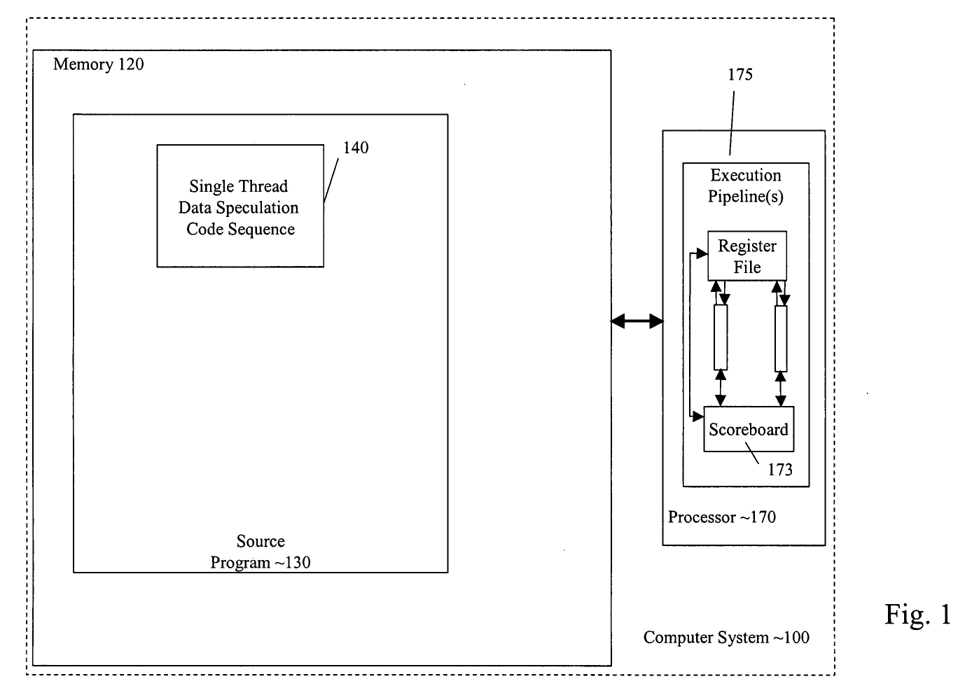

While memory 120 is illustrated as a unified structure in FIG. 1, this should not be interpreted as requiring that all memory in memory 120 is at the same physical location. All or part of memory 120 can be in a different physical location than processor 170. For example, method 540 may be stored in memory that is physically located in a location different from processor 170.

Processor 170 should be coupled to the memory containing method 540. This could be accomplished in a client-server system, or alternatively via a connection to another computer via modems and analog lines, or digital interfaces and a digital carrier line. For example, all of part of memory 120 could be in a World Wide Web portal, while processor 170 is in a personal computer, for example.

More specifically, computer system 100, in one embodiment, can be a portable computer, a workstation, a server computer, or any other device that can execute method 540. Similarly, in another embodiment, computer system 100 can be comprised of multiple different computers, wireless devices, server computers, or any desired combination of these devices that are interconnected to perform, method 540 as described herein.

Herein, a computer program product comprises a medium configured to store or transport computer readable code for method 540 or in which computer readable code for method 540 is stored. Some examples of computer program products are CD-ROM discs, ROM cards, floppy discs, magnetic tapes, computer hard drives, servers on a network and signals transmitted over a network representing computer readable program code.

Herein, a computer memory refers to a volatile memory, a non-volatile memory, or a combination of the two. Similarly, a computer input unit, e.g., keyboard 515 and/or mouse 518, and a display unit 516 refer to the features providing the required functionality to input the information described herein, and to display the information described herein, respectively, in any one of the aforementioned or equivalent devices.

In view of this disclosure, method 540 can be implemented in a wide variety of computer system configurations using an operating system and computer programming language of interest to the user. In addition, method 540 could be stored as different modules in memories of different devices. For example, method 540 could initially be stored in a server computer 580, and then as necessary, a module of method 540 could be transferred to a client device and executed on the client device. Consequently, part of method 540 would be executed on the server processor, and another part of method 540 would be executed on the processor of the client device.

In yet another embodiment, method 540 is stored in a memory of another computer system. Stored method 540 is transferred, over a network 504 to memory 120 in system 100.

Method 540 is implemented, in one embodiment, using a computer source program 130. The computer program may be stored on any common data carrier like, for example, a floppy disk or a compact disc (CD), as well as on any common computer system's storage facilities like hard disks. Therefore, one embodiment of the present invention also relates to a data carrier for storing a computer source program for carrying out the inventive method. Another embodiment of the present invention also relates to a method for using a computer system for carrying out method 540. Still another embodiment of the present invention relates to a computer system with a storage medium on which a computer program for carrying out method 540 is stored.

While method 540 hereinbefore has been explained in connection with one embodiment thereof, those skilled in the art will readily recognize that modifications can be made to this embodiment without departing from the spirit and scope of the present invention.

The functional units, register file 171, and scoreboard 173 are illustrative only and are not intended to limit the invention to the specific layout illustrated in FIG. 1. A processor 170 may include multiple processors on a single chip. Each of the multiple processors may have an independent register file and scoreboard or the register file and scoreboard may, in some manner, be shared or coupled. Similarly, register file 171 may be made of one or more register files. Also, the functionality of scoreboard 173 can be implemented in a wide variety of ways known to those of skill in the art, for example, hardware status bits could be sampled in place of the scoreboard. Therefore, use of a scoreboard to obtain status information is illustrative only and is not intended to limit the invention to use of only a scoreboard.

We claim:

1. A computer-based method comprising:
determining, under explicit software control, whether data speculation for an item is needed; and
performing data speculation, under explicit software control, for the item upon determining data speculation is needed.

2. The computer-based method of claim 1 further comprising:
executing an original code segment using an actual value of the item upon determining data speculation is not needed.

3. The computer-based method of claim 1 wherein the performing data speculation further comprises:
directing hardware to checkpoint a state to obtain a snapshot state.

4. The computer-based method of claim 3 wherein the state comprises a processor state.

5. The computer-based method of claim 3 wherein the performing data speculation further comprises:
setting a value of the item to a predicted value of the item.

6. The computer-based method of claim 5 wherein the performing data speculation further comprises:
executing an original code segment using the predicted value of the item in place of an actual value of the item.

7. The computer-based method of claim 6 wherein the performing data speculation further comprises:
comparing the predicted value to the actual value.

8. The computer-based method of claim 7 wherein the performing data speculation further comprises:
committing a result of executing the original code segment using the predicted value upon the predicted value being equal to the actual value.

9. The computer-based method of claim 7 wherein the performing data speculation further comprises:
rolling the state back to the snapshot state.

10. The computer-based method of claim 9 further comprising:
executing the original code segment using the actual value.

11. The computer-based method of claim 1 wherein the determining whether data speculation is needed comprises:
executing a branch on register status instruction.

12. The computer-based method of claim 11 wherein said branch on register status instruction is a branch on ready instruction.

13. A structure comprising:
means for determining, under explicit software control, whether data speculation for an item is needed; and
means for performing data speculation, under explicit software control, upon determining data speculation for the item is needed.

14. The structure of claim 13 further comprising:
means for executing an original code segment using an actual value of the item upon determining data speculation is not needed.

15. The structure of claim 13 wherein the means for performing data speculation further comprises:
means for directing hardware to checkpoint a state to obtain a snapshot state.

16. The structure of claim 15 wherein the state comprises a processor state.

17. The structure of claim 15 wherein the means for performing data speculation further comprises:
means for setting a value of the item to a predicted value of the item.

18. The structure of claim 17 wherein the means for performing data speculation further comprises:
means for executing an original code segment using the predicted value in place of an actual value.

19. The structure of claim 18 wherein the means for performing data speculation further comprises:
means for comparing the predicted value to the actual value.

20. The structure of claim 19 wherein the means for performing data speculation further comprises:
means for committing a result of executing the original code segment using the predicted value upon the predicted value being equal to the actual value.

21. The structure of claim 19 wherein the means for performing data speculation further comprises:
means for rolling the state back to the snapshot state.

22. The structure of claim 21 further comprising:
means for executing the original code segment using the actual value.

23. The structure of claim 13 wherein the means for determining whether data speculation is needed further comprises:
means for executing a branch on register status instruction.

24. A computer system comprising:
a processor; and
a memory coupled to the processor and having stored therein instructions wherein upon execution of the instructions on the processor, a method comprises:
determining, under explicit software control, whether data speculation for an item is needed; and
performing data speculation, under explicit software control, upon determining data speculation is needed.

25. A computer-program product comprising a medium configured to store or transport computer readable code for a method comprising:
determining, under explicit software control, whether data speculation for an item is needed; and
performing data speculation for the item, under explicit software control, upon determining data speculation is needed.

26. The computer-program product of claim 25 wherein the method further comprises:
executing an original code segment using an actual value of the item upon determining data speculation is not needed.

27. A computer-based method comprising:
executing a branch on register status instruction;
executing an original code segment using an actual value of the register upon the register status being a first state; and
performing, alternatively, data speculation under explicit software control for the original code segment, upon the register status being a second state different from the first state.

28. A structure comprising:
means for executing a branch on register status instruction;
means for executing an original code segment using an actual value of the register upon the register status being a first state; and
means for performing, alternatively, data speculation under explicit software control for the original code segment upon the register status being a second state different from the first state.

29. A computer system comprising:
a processor; and
a memory coupled to the processor and having stored therein instructions wherein upon execution of the instructions on the processor, a method comprises:
executing a branch on register status instruction;
executing an original code segment using an actual value of the register upon the register status being a first state; and
performing, alternatively, data speculation under explicit software control for the original code segment, upon the register status being a second state different from the first state.

30. A computer-program product comprising a medium configured to store or transport computer readable code for a method comprising:
executing a branch on register status instruction;
executing an original code segment using an actual value of the register upon the register status being a first state; and
performing, alternatively, data speculation under explicit software control for the original code segment, upon the register status being a second state different from the first state.

31. A method comprising:
determining whether data speculation is needed in a computer source program; and
inserting computer program code in the computer source program that upon execution provides explicit software control of the data speculation.
